(19) United States
(12) Patent Application Publication
(10) Pub. No.: US 2017/0014889 A1
(43) Pub. Date: Jan. 19, 2017

(54) TOOL SLIDE

(71) Applicant: voestalpine Giesserei Linz GmbH, Linz (AT)

(72) Inventor: Markus Meyer, Wangen im Allgäu (DE)

(21) Appl. No.: 15/123,790

(22) PCT Filed: Mar. 5, 2015
(86) PCT No.: PCT/EP2015/054662

§ 371 Date: Sep. 6, 2016

(30) Foreign Application Priority Data
Mar. 6, 2014 (DE) 10 2014 102 993.3

(51) Int. Cl. B21D 28/32; B30B 15/02; B21D 37/14

(52) U.S. Cl. CPC B21D 28/32; B21D 37/14; B30B 15/026

(57) ABSTRACT

A tool slide, having at least one slide bed and one slide body. The slide body is axially movable in a restricted guiding fashion on the slide bed. A groove is provided in the slide body or in the slide bed and as a corresponding means, a guide body of the slide body or slide bed is supported in an axially movable, guiding fashion in the groove. The guide body is embodied as rail-like or slat-like and is positioned with part of its width inserted in a secured fashion into a groove in the slide body or slide bed.

### FIELD OF THE INVENTION

The invention relates to a tool slide.

### BACKGROUND OF THE INVENTION

Tool slides, which are also referred to as wedge drives, are known.

Wedge drives are used in tools in metalworking, e.g. in forming presses. These wedge drives are usually connected to devices or tools that make it possible to perform a punching procedure or some other deforming procedure. A conventional wedge drive has an upper guide part, which includes a slide element and a slide guide element, and a lower guide part, which includes a driver element, or vice versa. On the slide guide element side, the wedge drives are moved by means of a drive that exerts a generally vertical pressing force. On the driver element side, wedge drives in the tool or press are fastened to a base plate onto which the workpiece to be machined is placed directly or by means of a corresponding support device.

DE 26 40 318 B2 has disclosed a wedge drive for converting a vertical pressing force into a force acting obliquely thereto for the forming process. This wedge drive is composed of a driving wedge, on which a vertical force of a corresponding working press acts, and a slide wedge, which transmits the force in the horizontal direction. The driver wedge and the slide wedge travel over a rounded cooperating region or in another embodiment, over a roller.

DE 24 39 217 A1 has disclosed a wedge press with a prism-shaped wedge guide in which the contact surfaces are embodied as roof-shaped or trough-shaped and in which the roof or trough extends across the entire pressure-absorbing width of the wedge.

DE 23 29 324 B2 has disclosed a wedge press with a device for preventing unwanted movements of the wedge with a prism-shaped wedge guide.

Usually, suspended wedge drives, which are used in the vehicle body industry, are composed of a driver, a slide, and a slide recess. The top side of the slide recess is acted on with a perpendicular force, which pushes the slide recess downward. The driver is firmly anchored in the tool so that when pressure is exerted on the slide recess, the slide that is anchored in the slide recess is pushed in any desired direction other than the perpendicular working direction.

Suspended wedge drives are used frequently. In this design, the slide is suspended in its guide so that it is able to move in the slide recess. The driver is supported rigidly in the lower part and predefines the working direction of the slide. With the downward stroke of the press, the decompressed slide comes to rest on the driver and is slid across the driver surface in the working direction by the continuing motion of the slide recess.

The wedge drives known from this prior art have disadvantages so that the slides used frequently have only a short service life and because of their structural design, are subject to intense wear. They must therefore be frequently replaced even after short service lives because they are experiencing wear phenomena so that a precise conversion of vertical pressing forces is no longer possible, which results in unacceptable tolerances in metalworking.

DE 197 53 549 C2 has disclosed a wedge drive, which can be produced in a continuous industrial production process and is supposed to have a long service life. To guide the slide in the slide recess, inclined strips are provided, which are made of bronze and are equipped with sliding elements made of graphite that are mounted in the inclined strips. Generally, this wedge drive for converting as vertical pressing force is equipped with a driver, a slide, and a slide recess; the driver has a prism guide and the path of travel of the slide on the driver is shorter than the path of travel of the slide on the slide recess, where the ratio of the paths of travel to each other is at least 1 to 1.5 and the angle α between the paths of travel is 50° to 70°. In a slide of this kind, the driver element has a prismatic surface, with the flanks of the prismatic surface being embodied as sloping down toward the outside. In addition, this wedge drive has forced retrieval brackets on two opposing sides, each in a respective groove of the slide element and driver element. If a spring element that returns the slide element to its starting position breaks, then these brackets ensure a retrieval of the slide element when spring breakage occurs, thus preventing the screwed-on stamp elements from tearing off. The slide element is fastened to the slide guide element by means of the inclined strips and retaining screws and can be moved along the inclined strips relative to the slide guide element.

U.S. Pat. No. 5,101,705 A has disclosed another wedge drive in which the slide element is suspended on inclined strips or is fastened by means of them to the slide guide element. In this case, the plates resting against one another and the elements required for the fastening must be ground precisely in order to ensure the necessary clearance between the slide element and the slide guide element. In this wedge drive and also in the other known wedge drives in which the slide guide element and slide element are connected to each other by means of inclined strips and screws, it is disadvantageous that all of the tensile forces are introduced into the screws, as a result of which particularly at the moment in which an expansion of the screws and of the material surrounding them occurs, there is a negative impact on the clearance of the slide guide elements and slide elements that are moving relative to each other. This subsequently results in a reduced service life since the wear in this region is particularly increased due to the distortion of the tool in this region. It also turns out to be disadvantageous that the slide element cannot expand laterally when it is heated because it is restricted in this regard by the inclined strips. This can likewise result in increased wear on the tool.

EP 1 197 319 A1 has disclosed a wedge drive in which the slide element and the slide guide element are held together by means of guide brackets. As a result, it should not be necessary for additional inclined strips or other elements that connect these two elements to be precisely ground in order to ensure a required clearance. In addition, there is no negative impact on the clearance even when the wedge drive and the tool are heated because not only production tolerances, but also accompanying expansions of the material can be absorbed by the connection by means of a guide bracket. The service life of the wedge drive is thus likewise no longer negatively affected or shortened. Despite the elimination of a grinding, it is possible to achieve a high degree of running accuracy. The guide brackets in this case engage in a form-fitting manner in the slide guide element so that the guide brackets suspend the slide element on the slide guide element by means of this form-fitting engagement. As a result of this, it is not necessary to provide a fastening to the slide guide element by means of screws, which are on the one hand susceptible to wear and on the other hand, can cause the above-mentioned negative impact on the clearance when they are heated.

DE 10 2007 045 703 A1 has disclosed a wedge drive with a slide recess in which a dovetail-like or prismatic guide device is provided between the slide element and the slide element recess. This document explains that with an approximately perpendicular approaching motion of a press tool, which is referred to as the working stroke, the slide element, which is in its rear position, comes to rest on the rigid protruding driver element and, supported by the latter, is driven by means of its inclined position oriented in the working direction. The movable slide element is thus driven only by the press tool and is steered forward or toward the outside, in order to be able to execute the stamping- or forming work. In the rearward stroke in which the press tool has moved beyond its lower suction point and its two pans are moving apart from each other again, usually the movable slide element is slid back into its starting position by means of a correspondingly designed spring-elastic element, after which the process can be started again. It is stated that the withdrawal force required for retrieval of the slide element is usually between 2% and 10% of the actual working force and weight of the slide element. In this case, the decisive factors for the magnitude of the pressing force should be the dimensions of the surfaces transmitting the pressure, which are referred to as slide surfaces, the respective inclinations of linear guides in the slide element recess, the inclination of the driver element, the interplay of the areas and inclinations, and the design of the slide element itself. The pressures to be transmitted are usually between <100 kN and up to several tens of thousands of kN.

It is also stated that the linear guidance in the slide element recess should guide the movable slide element without play and in so doing, must withstand powerful pressing forces and achieve a long service life. A tolerance of 0.02 mm is set as a tolerance of the running accuracy of the movable slide element.

As has also been explained in the prior art, such wedge drives or slides are composed of a slide assembly, which is in turn composed of a driver, a slide part, and a slide bed. In this connection, the slide part is fastened to the slide bed with retaining elements, with the slide part being suspended in sliding fashion between the driver and the slide bed. Corresponding inclined surfaces on the slide bed and driver are inclined in opposite directions so that the slide part is “pushed out” between the two parts when the slide bed and driver are brought together. Since, as explained above, very powerful forces occur in this case, a corresponding guide must be provided.

The known types of guidance in this case are cover strip guidance, guide bracket guidance, guide column guidance, and dovetail guidance (DE 10 2007 043 703 A1).

The overwhelming majority of these guides are mounted to the outer surface of the slide. In this case, it should be noted that the transmission of force and the guidance are not optimal. On the one hand, the main slide guidance by means of the slide surfaces must therefore be offset toward the inside, meaning that less transmission of force is possible. In addition, this frequently requires more space and deformations can be observed due to the introduction of operating forces (working- and withdrawal forces).

With the known dovetail guidance, it is disadvantageous that the play must be frequently remachined, which requires the slide to be completely dismantled. Furthermore, in all other sliders, installation and removal are very complex and labor-intensive. On the one hand, this can only be carried out toward the rear in the whole slide body; particularly in large sliders due to the high weight of the slide body and the extremely limited installation spaces, large masses must be moved in narrow guidance with the aid of a crane. With bracket slides, space to the side must be provided for the installation and removal so that for certain applications, there is no reliable guarantee that an optimized position of the slide will be achieved.

DE 10 2012 014 546 A1 has disclosed a wedge drive; the wedge drive should have a slide element recess, a movable slide carriage, and a driver and is embodied with slide surfaces between the slide carriage and the driver element; in at least one slide surface, a tensioning device should be provided, which adjustably simulates the pressing force during the installation of the working tool in order to achieve a play-free state between the at least one slide carriage and the at least one slide recess. According to this document, a high tolerance precision should be achieved, namely when the upper part of the slide, which includes the slide carriage and the slide element recess on the one hand and the driver on the other, is mounted in the tool; this is supposed to be achieved by the fact that when the working tool is mounted on the slide, i.e. when a working tool such as a hole punch is mounted on the slide, the slides are held together with the simulated pressing force.

In the known tool slides, it is disadvantageous that the installation and removal are very complex and time-consuming. On the one hand, slides of this kind can only be installed toward the rear in the whole slide body; particularly in large slides, this is difficult due to the weight of the slide body since very large masses must be moved in narrow guidance with the aid of a crane. In addition, the most common tool slides, namely slides with bracket guidance, require a significant amount of space for installation and removal.

The object of the invention is to create a slide guide that has optimized properties with regard to overall size and force transmission while improving the installation efficiency.

### SUMMARY OF THE INVENTION

According to the invention, a slide is embodied with a slide bed, a slide body, and a driver. In this case, the slide body is supported on the slide bed; to support the slide body on or in the slide bed, a longitudinally extending groove is provided and a guide body 15 extends into this longitudinally extending groove; the guide body 15 is held in the groove in sliding fashion with suitable means so that it is possible to move the guide body in the groove. According to the invention, however, the guide body in this case is not of one piece with the slide body, but instead rests in the slide body in a groove; at a groove opening on the end, this groove preferably has means with which the guide body is axially fixed in the groove. In the transverse direction, the guide body 15 is preferably held in the groove in such a way that along a longitudinal edge that is supported in the slide body, the guide body has a thickening or widening so that it cannot be pulled out of the groove.

Preferably, the guide body is also thickened or widened along a longitudinal edge inside the groove so that the suitable means provided in the groove can likewise prevent it from being pulled out of the groove in the transverse direction. In this respect, the slide body and the slide bed are only able to move axially relative to each other.

Naturally, a reversed support is also possible and in addition to a suspended slide, it is naturally also conceivable to have a standing slide in this configuration.

By removing the blocking element at the end of the groove—naturally, it is also possible to have blocking elements inside the groove, e.g. adapters or the like—the guide body can be pulled axially out of the groove supporting it in the slide body. It is thus easily possible to separate the slide body and slide bed from each other and it is also possible, for example in cases of wear, to replace the guide body by means of this.

In one embodiment according to the invention, the slide guide between the slide body and the slide bed is embodied as prism-shaped, in particular dovetail-shaped. In addition to the prism-shaped or dovetail-shaped embodiment, however, according to the invention, the guide play can be adjusted by means of an inclined surface, with a separate sliding element being provided for this.

In detail, this guide is used in a known slide assembly, which is composed of the driver, the slide part, and the slide bed, with the slide part being suspended in sliding fashion in the slide bed. Sliding pairs are positioned between the driver and the slide part.

With an in particular prism-shaped or dovetail-shaped embodiment, the slide bed, for example, has the dovetail-shaped recess for accommodating the dovetail-shaped tongue, with a sliding element being embodied on the outside of the dovetail-shaped tongue and on the actual slide surface. The sliding element is embodied with an inclined surface. This inclined surface can in this case be embodied either on the groove-side shorter surface of an L-shaped sliding element; then the groove is provided with a corresponding surface, in particular a corresponding inclined surface. The inclined surface for adjustment, however, can also be positioned on the inner surface of the sliding element and can thus act on the dovetail tongue, which can then likewise be embodied with a corresponding inclined surface, but does not have to. In this case, both of the sliding elements or only one sliding element can have the inclined surface. By sliding the sliding element along the direction of the inclined surface (usually in the longitudinal direction of the elongated slide strips), the guide play between the slide bed and the slide body is changed.

The L-shaped sliding element in this case can also be composed of individual sliding elements, which are arranged in an L shape relative to each other, but this increases the amount of installation effort.

Particularly in the case in which both of the sliding elements have the inclined surface, an adjustment of the slide bed relative to the slide body can also be achieved by sliding the slide strips in opposite directions.

According to the invention, the guide prism is not of one piece with the slide body, but is instead supported in the slide body in removable fashion in the form of a prism-shaped guide body that protrudes over the slide part.

As a result of this, the prism guidance can be slid in and removed at the rear, allowing the slide part to then be easily lifted up from the slide bed and vice versa.

According to the invention, this guide body can even be embodied with regard to the material so that it exhibits sliding properties since the separation of the prismatic guide body from the slide part according to the invention permits the materials used to be better matched, by and large, to their use.

### BRIEF DESCRIPTION OF THE DRAWINGS

The invention will be explained below by way of example based on the drawings. In the drawings:

FIG. 1: is a cut-away view of as tool slide according to the invention;

FIG. 2: is a partially cut-away view of another embodiment of the slide according to FIG. 1;

FIG. 3: shows the slide bed of the slide according to the invention with the adjustments of the slide strips;

FIG. 4: is a rear view of the adjustment state according to FIG. 3;

FIG. 5: shows the slide bed according to FIG. 3 in another adjustment view of the strips;

FIG. 6: is a rear view of the adjustment according to FIG. 5;

FIG. 7: is a perspective view of a slide assembly according to the invention, including the slide bed and the slide part, with the guide prism pulled part-way out;

FIG. 8: shows the slide assembly according to FIG. 7, with the slide part tilled up from the slide bed with the guide prism disassembled;

FIG. 9: shows a tool slide in the lifted state, with the driver at the bottom and the prism guide in the unfixed state, with gap dimensions;

FIG. 10: shows the tool slide according to FIG. 7 in the brought-together state; the production-induced offset is adjusted by means of the gap dimensions and the centering on the driver;

FIG. 11: shows the tool slide according to FIG. 7 in the brought-together state with fixed gap dimensions after the adjustment of the guide play by means of the adjustable strips;

FIG. 12: shows another embodiment of a tool slide having a catch element with a bayonet catch;

FIG. 13: is as top view of the embodiment according to FIG. 12;

FIG. 14: shows the embodiment according to FIG. 12 in a longitudinally sectioned view along the line A-A according to FIG. 13;

FIG. 15: is an exploded view of the tool slide according to FIG. 12;

FIG. 16: shows the tool slide according to FIG. 15 when disassembled;

FIG. 17: is a to view of the catch element;

FIG. 18: is a side view of the catch element;

FIG. 19: is another top view of the catch element;

FIG. 20: shows the catch element in top view relative to FIG. 17;

FIG. 21: is a perspective view of the catch element with a thrust element;

FIG. 22: shows a slide with cover strip guidance according to the prior art;

FIG. 23: shows a slide with column guidance according to the prior art;

FIG. 24: shows a slide with bracket guidance according to the prior art;

FIG. 25: shows a slide with dovetail guidance according to the prior art.

### DETAILED DESCRIPTION OF THE PREFERRED EMBODIMENTS

A tool slide 1 according to the invention has a slide bed 2, a slide body 3, and a driver 41.

In the case shown, the slide part 3 is arranged so that it is suspended on the slide bed 2; the slide part 3 can be lifted up from the driver 4. The driver 4 is usually positioned on a first tool half (the lower one in the case shown), while the slide part 3 is positioned above the slide bed 2 on a corresponding second (upper) tool half (not shown).

The slide bed 2 is embodied as approximately box-shaped and has an elongated rectangular groove 3; next to the elongated rectangular groove 5, screw holes 6 are provided to accommodate corresponding screws (not shown). The groove and the adjacent surfaces 7 delimiting the groove form a hearing surface for L-shaped slide strips 8, which rest on the surfaces 7 and extend into the groove with one L-leg 9. The L-shaped slide strips 8 have mounting holes 10 for screwing in mounting screws for insertion into screw holes 6. The L-shaped slide strips 8 have inclined surfaces 11 oriented toward the groove center with which they delimit a prismatic intermediate space between themselves. Toward the slide body 3, the L-shaped slide strips have slide surfaces 12, which are embodied as flat and are oriented perpendicular to a depicted x axis 13. Toward the surfaces 12, the slide body 3 has corresponding slide surfaces or slide strips 14, which are embodied as sliding partners for the L-shaped slide strips 8. Symmetrical to the vertical axis, a guide body 15 extends upward between the slide strips 14 and into the groove 5. For example, the guide body 15 has a guide prism, which has elongated prismatic surfaces 16 with which it rests against the surfaces 11 of the L-shaped slide strips.

The guide body 15 in this case is embodied as an elongated, rail-like or stud-like component, which widens out in prismatic fashion in region that protrudes into the groove 5 and is supported with a T-shaped region 30 in the slide body 3. The slide body 3 has a T-shaped groove 31 for this purpose and, adjacent to the slide surfaces 14, has a narrower region 32 that opens out to the surface and in the direction oriented away from the surface, widens out into a T-shaped region 34. Consequently, the guide body 15 has a narrower stud-like region 35, which in the wider region of the groove, widens out in a corresponding T-shaped fashion into a crossbar-like region.

In a modification relative to the exemplary embodiment shown, in order to provide a secure guidance and holding of the guide body 15 in the slide body 3, instead of using an approximately T-shaped embodiment it is also possible to use any other shape that widens from a narrower region out to a wider region, for example a rotund rod-shaped widening of the cross-section relative to the longitudinal span of the guide body, a triangular or prism-shaped widening, and the like.

Correspondingly, the guide prism 15a, which is positioned in the grove 5, can also be embodied in shapes other than a prismatic shape, as long as a widening provides assurance that a suspended arrangement of the slide body in the slide bed will be guaranteed.

Oriented toward the driver, the slide body has other slide strips 17, which are inclined relative to the x axis 13 and correspond to prismatic guide surfaces 18 of the driver 4. The strips 17, because they are connected to the slide body, constitute liftable slide strips, which are brought into an operative connection with the surfaces 18 when the upper part and bottom part of the tool are brought together.

Since the guide surfaces of the L-shaped slide strips 8 and the corresponding surfaces 12 of the strips 14 are perpendicular to the x axis 13 and are also perpendicular to the guide prism 15, this embodiment is referred to as a so-called flat guide.

The inclined corresponding sliding elements 17, 18 between the slide body and driver form a so-called prism guide.

In another advantageous embodiment (FIG. 2, the same parts are provided with the same reference numerals), the tool slide 1 is likewise composed of a slide bed 2 and a slide body 3 the driver 4 is not shown).

In the case shown, the slide part 3 is positioned on the slide bed 2 in suspended fashion; the slide part 3 can be lifted up from the driver 4. The slide bed 2 is approximately box-shaped and has an elongated groove 5; the groove 5 has groove side walls 19, which extend in converging fashion and consequently form a dovetail groove section. The surfaces 7 delimiting the groove 5 converge from each other (sic) and extend approximately perpendicular to the groove side walls 19 and parallel to the respective surfaces of the groove bottom 5a. The surfaces 7 have L-shaped slide strips 8 resting on them, which extend into the groove with a narrow, short L-leg 9. The L-shaped slide strips have contact surfaces 11 oriented toward the surfaces 7 and have slide surfaces 12 oriented toward the slide body 3, which are flat and are embodied as diverging in an inclined fashion relative to a vertical axis. These surfaces 12 slide on corresponding slide surfaces 14 of the slide body 3.

The slide surfaces 14 of the slide body 3 are consequently embodied as inclined in roof-shaped fashion; the guide prism 15 of the slide body is positioned so that in the middle, it is centrally situated in symmetrical fashion relative to the vertical axis; and the prismatic surfaces 16 are embodied as resting against the short L-shaped legs 9 of the slide strips 8. The surfaces 16 and 14 in this case enclose the same angle as the surfaces 9, 12 and in the example shown, are approximately perpendicular to each other.

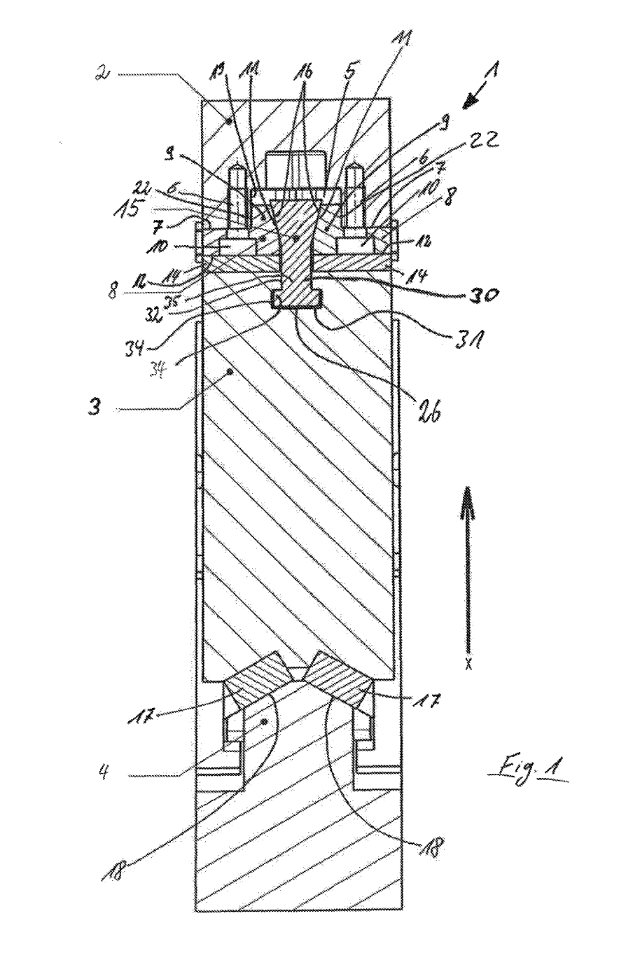

In the partially cut-away view shown in FIG. 2, it is clear that the guide body 15 in the groove 31 is secured from being pulled out axially by means of a cover disc 36 with a screw 37; the screw 37 is screwed into the slide body and the disc 36 covers parts of the groove 31 and the guide body 15 supported therein. This securing is also provided in an embodiment according to FIG. 1.

Instead of a cover disc 36 with a screw 37 for securing the guide body 15, in another advantageous embodiment, as form-fitting securing element 40 is provided. The catch element 40 is embodied as a flattened cylinder and has a bayonet-like catch with two opposing bayonet tongues 41 and an overhanging flange 42 on a second plane. The bayonet tongues 41 in this case are in particular positioned on curved circumference walls 44 of the catch element 40, whereas the overhanging flange 42 is embodied at a free end and protrudes beyond as flattened wall 45 of the catch element 40.

The catch, which is embodied as bayonet-like and equipped with the tongues 41, engages in a groove 46 and thus secures components situated behind it (e.g. tongue, guide piece) at different contact surfaces.

For example, the tongue can be secured once in the center of the catch element and once at the overhanging flange.

The bayonet catch is embodied so that by rotating the catch element 40 to a certain angle (e.g. 90°), the bayonet-like geometry on the first level is released, i.e. the tongues 41 come out of the groove 46, and the catch element can then be removed from the mounting position in the arrow direction 43.

The catch element 40 is embodied as self-locking in the mounting position by means of a flexible thrust element 47, which is particularly positioned in a bore 48 in a radial circumference wall 49 of the overhanging flange 42. In the mounting position, the flexible thrust element 47 engages in an opposing notch or bore 50 so that it is only possible to rotate the catch element 40 by increasing the force exerted.

Depending on the requirements, the guide body 15 can be composed of a material that differs from the conventional cast material of the slide body 3. Forged steels can be used here, for example, depending on the forces to be expected.

Naturally, it is also possible to embody the guide body as hardened or to provide the guide body with hard coatings (for example using the PVD method) in order to achieve a particularly high wear resistance.

Since it is necessary to achieve an exact fit and guidance of the tool slide, particularly between the slide bed and the slide body, the guidance of the slide body in the slide bed must be adjustable or more precisely, the slide strips 8 and the prism 15 must be adjusted relative to one another.

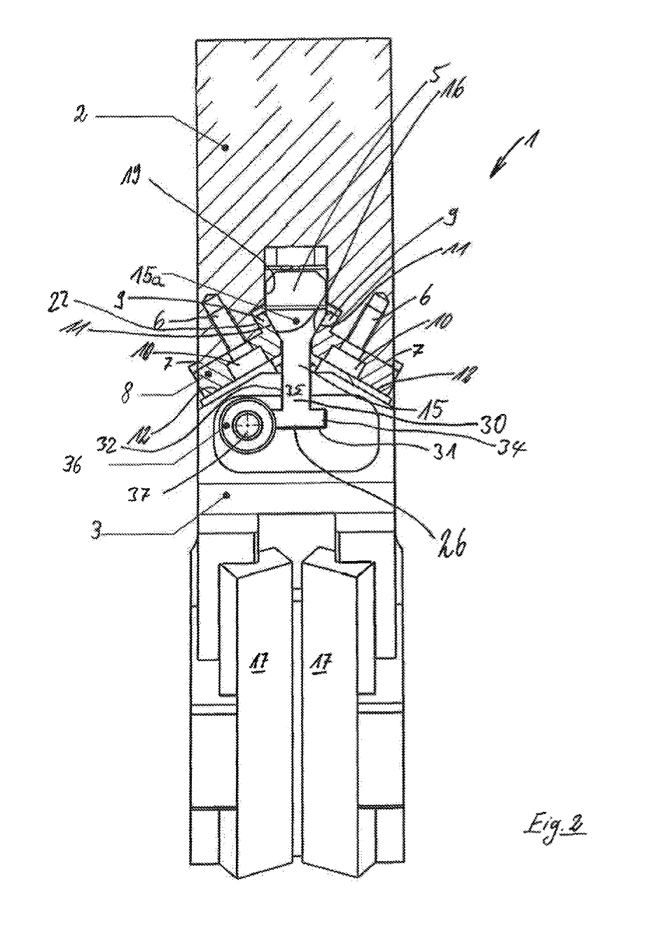

To this end, (FIGS. 3 through 6) the mounting holes 10 in the slide strips 8 are embodied as oblong holes so that the strips can be moved along the mounting screws 20 and thus along an adjustment direction 21.

The movement of the slide strips 8 along the direction 21 does not change anything yet with regard to possibly existing gaps or spaces between the surfaces of the slide strips 8 or L-legs 9 and of the guide prism 15. With regard to the longitudinal span or the directions 21, therefore, the contact surfaces 11 of the L-legs 9 of the L-shaped slide strips 8 are inclined. This means that they change in thickness over their longitudinal span. The inclined surface has a slope of 1-5 degrees, for example.

The inclined contact surfaces 22 on the L-legs 9 of the L-shaped slide strips 8 are oriented toward corresponding surfaces 16 of the guide prism 15.

Because of the inclined surface 11, a sliding along the direction 21 therefore causes the distance between the L-legs 9 and the surfaces 16 to be reduced or eliminated. In this case, it is possible for both of the slide strips 8 to be moved or for only one slide strip 8 to be moved.

To adjust the play, a wedge-like or wedge-shaped inclined surface can be provided between the inner surfaces 22 of the L-legs 9, i.e. the surfaces 22 that are oriented toward the groove side walls 19. In addition, the groove side walls 19 at least in the vicinity of the contact of the surfaces 22 can be embodied with corresponding wedge-like or wedge-shaped inclined surfaces. A sliding along the direction 21 causes the slide strips 8 to move toward the guide prism 15 or away from it. Since this simultaneously causes the slide strips to come closer to each other or move farther away in the transverse direction, i.e. the direction 23, the oblong holes 10 in this case are embodied so that they also enable a floating support in the direction 23 around the screws 20.

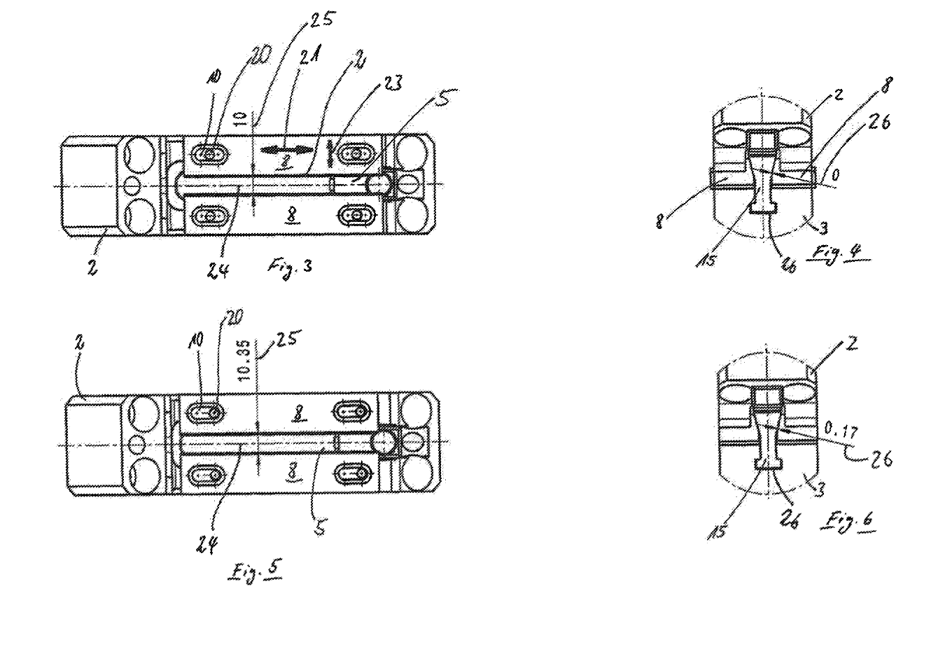

In order to adapt the slide strips 8 to the guide prism 15 and thus also to adapt the exact position of the slide body in the slide bed, it is possible, for example, to perform the adjustment from a stop position of the screws (20) in the oblong holes 10 (FIG. 5). In this open adjustment (FIGS. 5 and 6), there is a gap 25, for example, between a groove center 24 of the guide prism 15 and the corresponding wall of the slide strips 8.

If the L-shaped slide strips 8 are then slid in the direction 21 so that the oblong holes and the screws are situated, for example, in a central position (FIG. 3), then the gap 25 is reduced by means of the inclined surfaces 22 (FIG. 4).

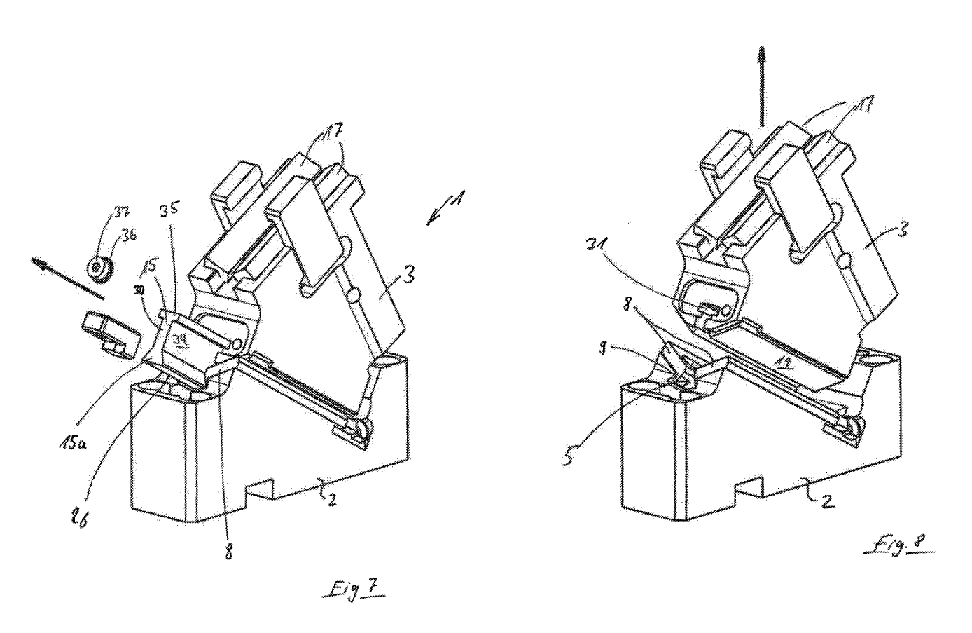

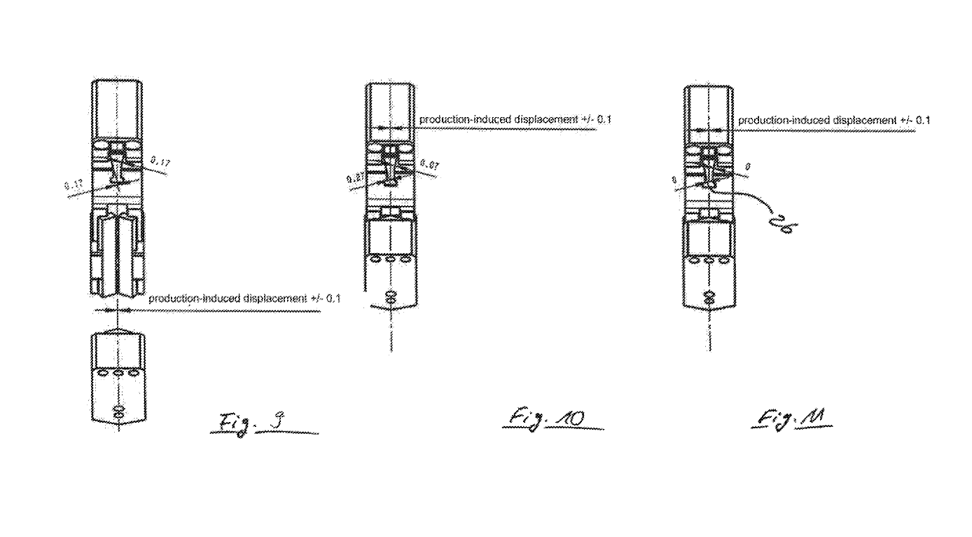

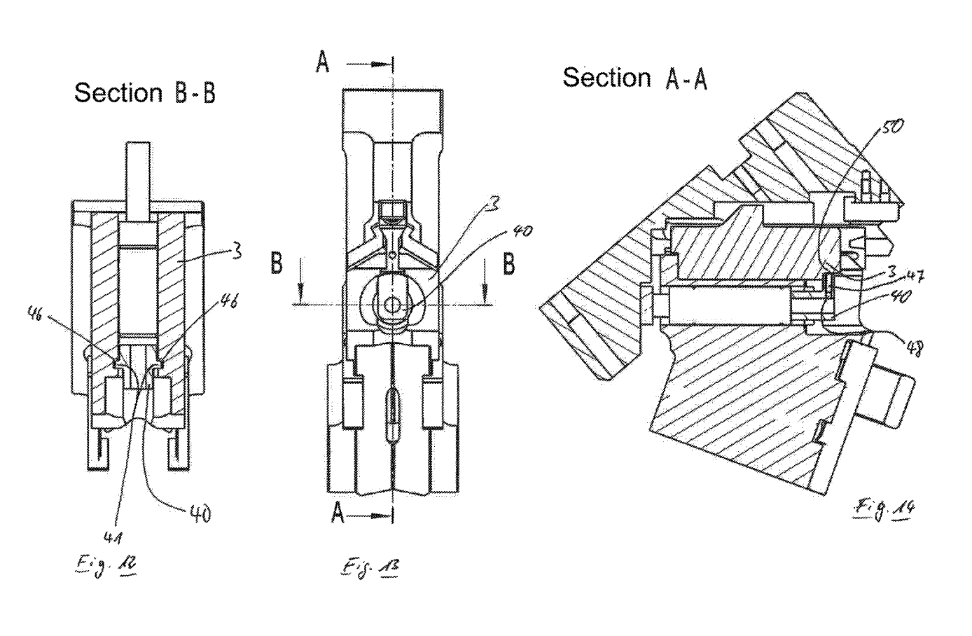

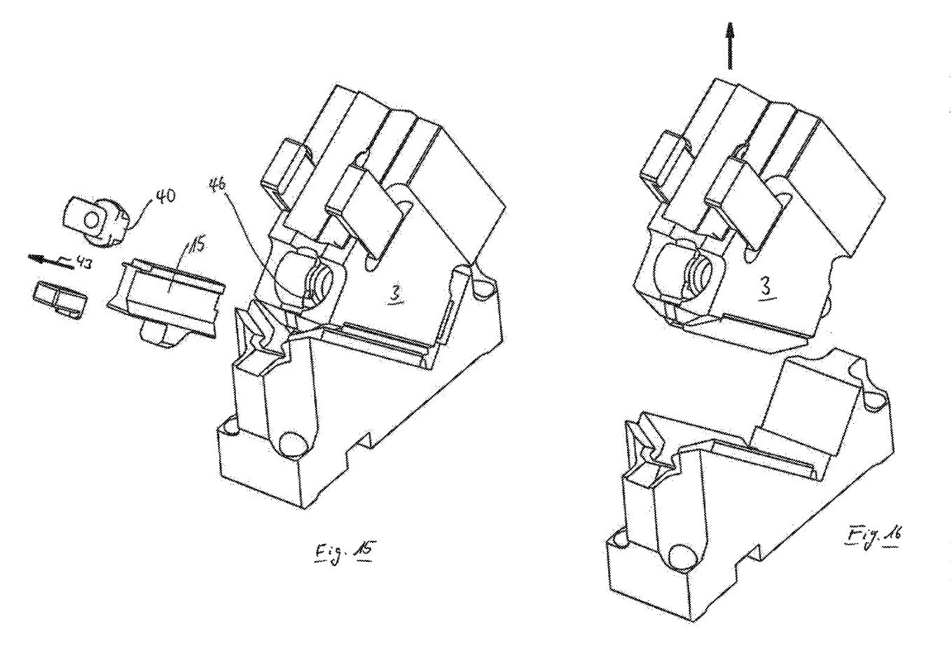

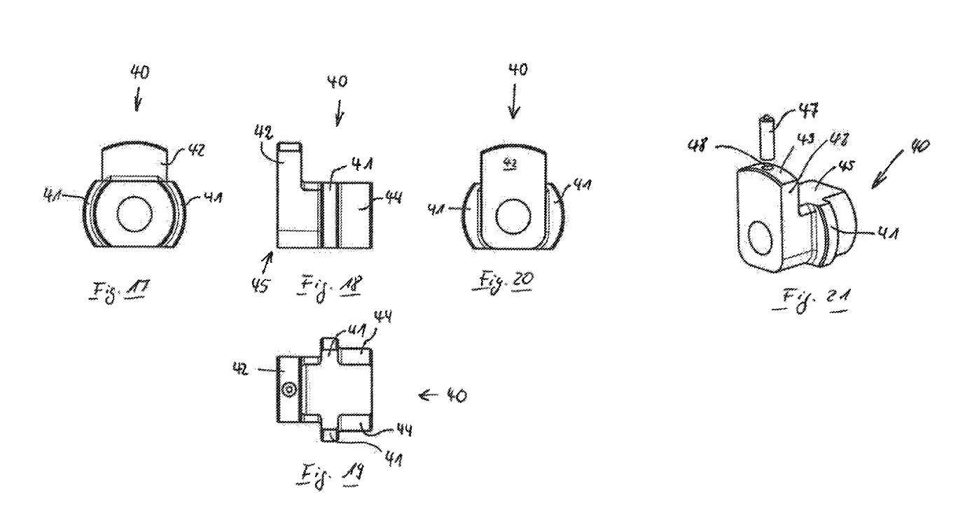

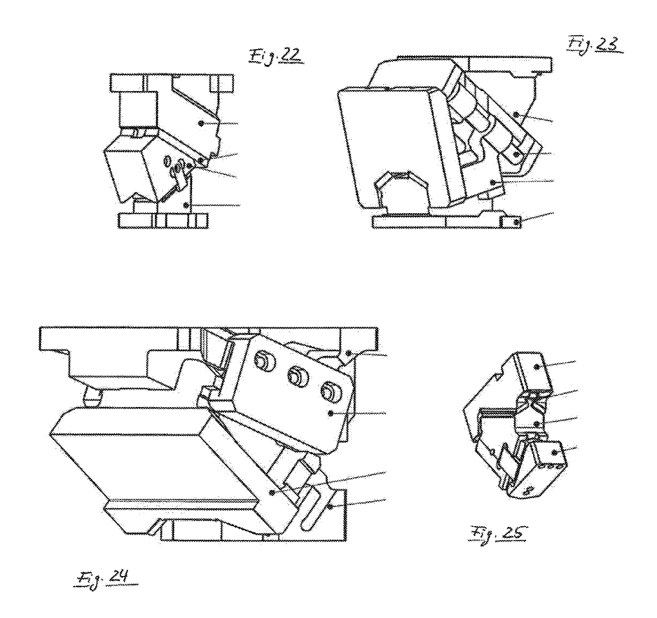

This can also be used in a tool slide with a flat guide (FIG. 1) to adjust a production-induced offset between the slide bed with the slide part in the upper part of the slide and the driver in the lower part (FIGS. 9 through 11).

To this end, the slide bed with the slide part is mounted on the tool with play between the slide strips 8 and the guide prism 15. The gap dimensions between the corresponding surfaces of the L-legs 9 and of the guide prism 15 therefore each have a respective gap with a first gap dimension that depends on the slope of the inclined surface, the production tolerances, and the position of the slide parts relative to one another. After the guide strips 17 are placed onto the driver 3, a production-induced offset between the slide bed with the slide part one the one hand and the driver on the other is compensated for. The slide centers itself. In this centered state, the L-shaped slide strips 8 can still be slid further so that finally, in the contacting state, the guide play and the gaps are eliminated. This ensures that even in the brought-together state of the press, extremely strict tolerances are set by means of the movable slide strips.

The invention relates to a tool slide, having at least one slide bed 2 and one slide body 3; the slide part 3 is axially movable in a sliding, restricted fashion on the slide bed 2; a groove 5 is provided in the slide part 3 or in the slide bed (2) and as a corresponding means, a guide body 15 of the slide part 3 or slide bed 2 is supported in axially movable, sliding fashion in the groove; and the guide body 15 is embodied as rail-like or slat-like and is positioned with part of its width inserted in a secured fashion into a groove 31 in the slide body 3 or slide bed 2.

The invention also relates to a tool slide, wherein the guide body 15 has a thickening or widening 34 along a longitudinal edge that is supported in the slide body.

The invention also relates to a tool slide, with the guide body 15 widening in a T-shaped fashion, from a narrower stud-like region 35 out to a crossbar-like region 36 in the direction toward the longitudinal edge 26.

The invention also relates to a tool slide, wherein in the region of an axial opening of the groove 31 in which it is secured, the guide body 15 is secured against axially sliding by a blocking means 36, 37.

The invention also relates to a tool slide according to one of the preceding claims, wherein the guide body 15 is embodied as an elongated rail-like or stud-like component; the guide body 15 is embodied so that it widens out in prismatic fashion into the region that protrudes into the groove 5; a guide prism 15a is provided, which is supported in the groove 5; and the guide body 15 is supported in the groove 5 with prismatic surfaces 16 against corresponding surfaces 11 of slide strips 8.

In the invention, it is advantageous that the ability of the guide body to be removed and inserted by being slid toward the back or the front allows it to be installed and removed easily.

1. A tool slide, comprising:
at least one slide bed;
a slide body that is axially movable in a restricted fashion on the slide bed;
a first groove in the slide body or in the slide bed; and
a guide body of the slide body or slide bed supported in an axially sliding fashion in the first groove, wherein the guide body is embodied as rail-like or slat-like and is positioned with part of its width inserted in a secured fashion into a second groove in the slide body or slide bed.

2. The tool slide according to claim 1, wherein along a longitudinal edge that is supported in the slide body, the guide body has a thickening or widening.

3. The tool slide according to claim 2, wherein the guide body widens in a T-shaped fashion, from a narrower stud-like region out to a crossbar-like region in a direction toward the longitudinal edge.

4. The tool slide according to claim 1, wherein in a region of an axial opening of the second groove in which the guide body is secured, the guide body is secured against axially sliding by a blocking means.

5. The tool slide according to claim 1, wherein the guide body is an elongated rail-like or stud-like component that widens out in a prismatic fashion into a region that protrudes into the first groove; a guide prism is provided, which is supported in the first groove; and the guide body is supported in the first groove with prismatic surfaces against corresponding surfaces of slide strips.

6. The tool slide according to claim 1, further comprising a form fitting catch element in order to secure the guide body, wherein the catch element has a bayonet-like catch and cooperates with corresponding bayonet catch means on the slide body.

7. The tool slide according to claim 6, wherein the catch element has two opposing bayonet tongues, which are embodied so that the bayonet tongues each cooperate with a respective groove in the slide body.

8. The tool slide according to claim 6, wherein the catch element is embodied as a flattened cylinder and the bayonet tongues are positioned on curved circumference walls (44) of the catch element, and an overhanging flange is embodied at a free end of the catch element and protrudes beyond a flattened wall of the catch element; and the catch element secures components situated behind the catch element at different contact surfaces.

9. The tool slide according to claim 6, wherein the bayonet catch is embodied so that by rotating the catch element to a certain angle, the tongues come out of the groove so that the catch element can then be removed from a mounting position.

10. The tool slide according to claim 6, wherein the catch element is arranged in self-locking fashion in a mounting position by a flexible thrust element, which is positioned in a bore in a radial circumference wall of the overhanging flange and, in the mounting position, the flexible thrust element engages in an opposing notch or bore so that it is only possible to rotate the catch element by increasing the force exerted.
